(19) United States
(12) Patent Application Publication
(10) Pub. No.: US 2007/0137525 A1
(43) Pub. Date: Jun. 21, 2007

(54) Water-soluble inorganic composition, plasticized substance, and foamed inorganic substance

(75) Inventors: Hiroshi Kokuta, Chigaski-shi (JP); Katsuhiro Kokuta, Chigaski-shi (JP); Hideaki Uchida, Sagamihara-shi (JP); Kenji Kokuta, Chigaski-shi (JP); Naoto Kokuta, Himeji-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HIROSHI KOKUTA, Chigasaki (JP)

(21) Appl. No.: 11/649,289

(22) Filed: Jan. 4, 2007

Related U.S. Application Data
(63) Continuation-in-part of application No. 10/467,277, filed on Aug. 6, 2003, now abandoned.

(30) Foreign Application Priority Data
Feb. 8, 2001 (JP) 2001-032671

(51) Int. Cl. C09D 1/00; C09D 5/20; C04B 40/00

(52) U.S. Cl. 106/286.1; 106/286.7; 106/286.8; 106/2; 106/819

(57) ABSTRACT

A water-soluble inorganic composition obtained by reacting an inorganic dissolution promoter with at least one solute selected from the group consisting of metal silicon, boric acid, and borax at a ratio of the inorganic dissolution promoter to the solute of 1:10 to 1:100 by weight, wherein the inorganic dissolution promoter is obtained by mixing in water (A) at least one compound selected from the group consisting of an alkali metal fluoride, an alkali metal phosphite, an alkali metal sulfite, an Alkali metal nitrite, sulfurous acid, nitrous acid, and phosphorous acid, alkali metal phosphate, alkali metal nitrate, alkali metal sulfate, phosphoric acid, nitric acid, sulfuric acid and (B) at least one alkali metal hydroxide at a ratio of (A):(B) of 1:9 to 4:1 by weight; a plasticized substance; and a foamed inorganic substance are provided. According to the present invention, a homogeneous and high concentration aqueous solution of a water-soluble inorganic composition is provided by homogeneously dissolving water-insoluble metal silicon or a scarcely water-soluble inorganic boron compound in water in an excess amount without causing these inorganic materials to remain at the bottom of the reactor, and a plasticized substance and foamed inorganic substance excelling in processability and handling properties and useful as a civil engineering and construction material are also provided.

### BACKGROUND OF THE INVENTION

1. Field of the Invention

The present invention relates to a water-soluble inorganic composition which is obtained by causing a metal silicon insoluble in water or an inorganic boron compound scarcely soluble in water to become homogeneously dissolvable in water at a high concentration without having an excessive amount of inorganic materials remain in the bottom, and to a plasticized substance and foamed inorganic substance excelling in processability and handling properties and useful as a civil engineering and construction material, obtained by vaporizing and dehydrating the water-soluble inorganic composition by heating at 100 to 900° C. to reduce the water content to a prescribed amount.

2. Description of Related Art

Conventionally, civil engineering and construction materials made from a light and inexpensive synthetic resin are widely used in the field of civil engineering works, construction, and the like.

However, these civil engineering and construction materials made from a light and inexpensive synthetic resin have a problem of polluting the environment because they cause a problem of exhaust gas pollution, if incinerated, and are not reduced to nature if dumped.

On the other hand, inorganic compounds do not cause a problem of polluting the environment, because they are incombustible and are reduced to nature if dumped. Therefore, development of materials for civil engineering works and buildings using such an inorganic compound is desired.

Relating to the present invention, JP-A-1-313303 (JP-B-7-14801, hereinafter referred to as Patent Document 1) discloses an aqueous film-forming inorganic compound, prepared by a reaction of a metal, a mineral acid compound capable of dissociating boric acid or hydrofluoric acid by hydration, and an alkali metal, by a process comprising reacting a solid metal with a concentrated solution of an alkali metal in water at the bottom of a reaction vessel or in a solution of the mineral acid compound, further reacting with the mineral acid compound while controlling the reaction temperature at 50 to 100° C., and forming the resulting product with a specific gravity of 1.1 or more into film at room temperature or while heating.

Patent Document 1 describes that the aqueous film-forming inorganic compound (a) can be used as a curing agent such as magnesia cement and the like, (b) can prevent ignition and improve heat resistance of paper or fiber, if applied to the paper or fiber, (c) can increase the melting point of glass cloth if applied to the glass cloth, (d) can prevent ignition and prevent smoke emission of wood if the wood is impregnated with it, or (e) can be used as a rust preventive if applied to a metal.

However, the Patent Document 1 does not describe the possibility of obtaining a plasticized substance with a desired water content from the resulting aqueous film-forming inorganic compound (an aqueous solution) by heating the compound at 100 to 900° C. to cause it to vaporize, dehydrate, and bubble.

The reaction for preparing the aqueous film-forming inorganic compound described in examples of the Patent Document 1 takes place according to the natural solubility occurring at the bottom of the reaction vessel. For this reason, it was necessary to cause an excess amount of water-insoluble or scarcely water-soluble raw materials to always exist in the bottom of the reaction system. This, however, causes the reaction to proceed only non-uniformly and allows metal silicon and the like to remain unreacted at the bottom of the reaction vessel. Therefore, the yield of the reaction for preparing the aqueous film-forming inorganic compound was low, quality control of the product separation was difficult, and the product quality was not constant.

JP-A-8-73212 (hereinafter referred to Patent Document 2) describes a high concentration boric acid compound obtained by mixing an aqueous solution of a sequestering agent or an aqueous solution of a wetting pervious surfactant with a boric acid compound to a concentration of 5 g/100 g of water or more and subjecting the mixture to a hydrothermal reaction at a temperature of 60° C. or more, and a fire-preventing, fire-resistant material produced from a fire-preventing, fire-resistant composition containing the high concentration boric acid compound.

However, in order to obtain the high concentration boric acid compound described in Patent document 2, an aqueous solution of a sequestering agent or a wetting pervious surfactant is required. In addition, the Patent Document 2 does not describe the possibility of obtaining a plasticized substance with a desired water content by vaporizing and dehydrating the resulting high concentration boric acid compound (an aqueous solution) by heating it at 100 to 900° C.

### SUMMARY OF THE INVENTION

An object of the present invention is to provide a water-soluble inorganic composition which is obtained by homogeneously dissolving a water-insoluble metal silicon or a scarcely water-soluble boron compound in water at a high concentration, a plasticized substance obtained by vaporizing and dehydrating the water-soluble inorganic composition by heating at 100 to 900° C. to a prescribed water content, and a formed inorganic substance.

As a result of extensive studies in order to achieve the above object, the inventors of the present invention were successful in obtaining a homogeneous and high concentration aqueous solution of an amorphous water-soluble inorganic composition (a water-soluble inorganic composition) by reacting an inorganic dissolution promoter with at least one solute selected from the group consisting of metal silicon, boric acid, and borax in water at a ratio of the Inorganic dissolution promoter to the solute of 1:10 to 1:100 by weight, wherein the inorganic dissolution promoter is obtained by mixing (A) at least one compound selected from the group consisting of an alkali metal fluoride, an alkali metal phosphite, an alkali metal sulfite, an alkali metal nitrite, sulfurous acid, nitrous acid, and phosphorous acid, alkali metal phosphate, alkali metal nitrate, alkali metal sulfate, phosphoric acid, nitric acid, sulfuric acid and (B) at least one alkali metal hydroxide at a ratio of(A):(B) of 1:9 to 4:1 by weight The inventors have found that a plasticized substance with a desired water content can be obtained by vaporizing and dehydrating the resulting water-soluble inorganic composition by heating it at 100 to 900° C. This finding has led to the completion of the present invention

According to a first aspect of the present invention, a water-soluble inorganic composition described in (1) to (6) below is provided.

(1) A water-soluble inorganic composition obtained by reacting an inorganic dissolution promoter with at least one solute selected from the group consisting of metal silicon, boric acid, and borax in water at a ratio of the inorganic dissolution promoter to the solute of 1:10 to 1:100 by weight, wherein the inorganic dissolution promoter is obtained by mixing (A) at least one compound selected from the group consisting of an alkali metal fluoride, an alkali metal phosphite, an alkali metal sulfite, an alkali metal nitrite, sulfurous acid, nitrous acid, and phosphorous acid, alkali metal phosphate, alkali metal nitrate, alkali metal sulfate, phosphoric acid, nitric acid, sulfuric acid and (B) at least one alkali metal hydroxide at a ratio of (A):(B) of 1:9 to 4:1 by weight.

(2) The water-soluble inorganic composition described in (1), obtained by using, 100 to 500 parts by weight of water per one part by weight of the inorganic dissolution promoter.

(3) The water-soluble inorganic composition described in (1) or (2), wherein the solute is metal silicon and the aqueous solution has a pH of 10.6 to 13.5 at 20° C.

(4) The water-soluble inorganic composition described in (3), which is an aqueous solution obtained by further adding boric acid, borax, or a boron compound containing the boric acid or borax to the reaction system when reacting the inorganic dissolution promoter with the solute.

(5) The water-soluble inorganic composition described in (1) or (2), wherein the solute is boric acid or borax and the aqueous solution has a pH of 4 to 9 at 20° C.

(6) The water-soluble inorganic composition described in any one of (1) to (5), obtained by adding and mixing 5 to 50 parts by weight of an acid-containing alcohol to 100 parts by weight of the reaction solution of the inorganic dissolution promoter and the solute, wherein the acid-containing alcohol is obtained by adding 1 to 10 parts by weight of at least one acid selected from the group consisting of sulfuric acid, nitric acid, hydrochloric acid, and phosphoric acid to 100 parts by weight of an alcohol having 1 to 4 carbon atoms.

According to a second aspect of the present invention, a plasticized substance described in the following (7) and (8) below is provided.

(7) A plasticized substance obtained by vaporizing and dehydrating the water-soluble inorganic composition described in any one of (1) to (6) to a prescribed water content by heating it at 100 to 900° C.

(8) The plasticized substance described in (7), having a water content of 30 wt % or less.

According to a third aspect of the present invention, a foamed inorganic substance described in (9) below is provided.

(9) A foamed inorganic substance obtained by adding at least one compound selected from the group consisting of (a) a soluble silicic acid compound, (b) an amorphous silicic acid compound, and (c) water, a polyol, and an isocyanate curing agent, to the water-soluble inorganic composition according to any one of (1) to (6), and mixing these materials at a prescribed temperature.

According to the present Invention, a homogeneous and high concentration aqueous solution of an amorphous water-soluble inorganic composition (water-soluble inorganic composition) is provided by homogeneously dissolving water-insoluble metal silicon or a scarcely water-soluble inorganic boron compound in water in an excess amount without causing these inorganic materials to remain at the bottom of the reactor.

A homogeneous water-soluble inorganic composition in which metal silicon and an inorganic boron compound are dissolved in water at a high concentration is provided according to the present invention.

The water-soluble inorganic composition of the present invention does not cause a problem of environmental pollution even if incinerated or dumped.

According to the present invention, a plasticized substance useful as a material for civil engineering works and building construction (for example, durable heat insulating material etc.) excelling in processability and handling properties can be provided by vaporizing and dehydrating the above-mentioned water-soluble inorganic composition by heating at 100 to 900° C. to a predetermined water content.

### BRIEF DESCRIPTION OF THE DRAWINGS

FIG. 1 shows an X-ray diffraction pattern of the water-soluble inorganic composition obtained in Example 7.

### DETAILED DESCRIPTION OF THE PREFERRED EMBODIMENT

1) Water-soluble inorganic composition

The water-soluble inorganic composition of the present invention is obtained by reacting an inorganic dissolution promoter with at least one solute selected from the group consisting of metal silicon, boric acid, and borax (the last two compounds are referred to from time to time as “inorganic boron compound”) in water at a ratio of the inorganic dissolution promoter to the solute of 1:10 to 1:100 by weight, wherein the inorganic dissolution promoter is obtained by mixing (A) at least one compound selected from the group consisting of an alkali metal fluoride, an alkali metal phosphite, an alkali metal sulfite, an alkali metal nitrite, sulfurous acid, nitrous acid, and phosphorous acid, alkali metal phosphate, alkali metal nitrate, alkali metal sulfate, phosphoric acid, nitric acid, sulfuric acid and (B) at least one alkali metal hydroxide at a ratio of (A):(B) of 1:9 to 4:1 by weight.

(Inorganic dissolution promoter)

The inorganic dissolution promoter is obtained by mixing in water (A) at least one compound selected from the group consisting of an alkali metal fluoride, an alkali metal phosphite, an alkali metal sulfite, an alkali metal nitrite, sulfurous acid, nitrous acid, and phosphorous acid and (B) at least one alkali metal hydroxide at a ratio of (A):(B) of 1:9 to 4:1 by weight.

Component (A)

The component (A) is at least one compound selected from the group consisting of an alkali metal fluoride, an alkali metal phosphite, an alkali metal sulfite, an alkali metal nitrite, sulfurous acid, nitrous acid, and phosphorous acid, alkali metal phosphate, alkali metal nitrate, alkali metal sulfate, phosphoric acid, nitric acid, sulfuric acid. It is preferable that the component (A) is at least one compound selected from the group consisting of an alkali metal fluoride, an alkali metal phosphite, an alkali metal sulfite, an alkali metal nitrite, sulfurous acid, nitrous acid, and phosphorous acid.

As examples of the alkali metal, lithium, sodium, potassium, and the like can be given.

As specific examples of the alkali metal fluoride, lithium fluoride, sodium fluoride, potassium fluoride, and the like can be given.

As specific examples of the alkali metal phosphite, sodium phosphite, potassium phosphite, and the like can be given.

As specific examples of the alkali metal sulfite, sodium sulfite, potassium sulfite, and the like can be given.

As specific examples of the alkali metal nitrite, sodium nitrite, potassium nitrite, and the like can be given.

These compounds may be used either individually or in combination of two or more.

Component (B)

The component (B) is at least one alkali metal hydroxide.

As specific examples of the alkali metal hydroxide, lithium hydroxide, sodium hydroxide, potassium hydroxide, cesium hydroxide, and the like can be given. These alkali metal hydroxides may be used either individually or in combination of two or more.

The inorganic dissolution promoter used in the present invention can be obtained by mixing the above-mentioned component (A) and component (B) at a ratio of 1:9 to 4:1 by weight.

A water-insoluble or scarcely water-soluble solute, which is at least one compound selected from a metal silicon, boric acid, and borax, can be homogeneously dissolved in water and a homogeneous aqueous solution of a high concentration amorphous water-soluble inorganic composition (water-soluble inorganic composition) can be efficiently produced by mixing the above-mentioned component (A) and component (B) at a ratio in the defined range.

Neither the method of mixing the above-mentioned component (A) and component (B) nor the order of addition of these components is specifically limited. This will be discussed in more detail in connection with the water-soluble inorganic composition.

In the case in which the later-described metal silicon is used as the solute, it is preferable to add an inorganic boron compound to the reaction solution in addition to the inorganic dissolution promoter.

When the inorganic boron compound is added, the amount to be added is such that the ratio by weight of total of the inorganic dissolution promoter and the inorganic boron compound to metal silicon, (inorganic dissolution promoter+inorganic boron compound): (metal silicon), is 1:10 to 1:100.

(Water-soluble inorganic composition)

The water-soluble inorganic composition of the present invention is obtained by reacting the above-mentioned inorganic dissolution promoter with at least one solute selected from metal silicon, boric acid, and borax in water at a ratio by weight of the inorganic dissolution promoter to the solute of 1:10 to 1:100.

Neither the method of mixing the component (A), component (B), and the solute, nor the order of addition of these components is specifically limited in preparing the water-soluble inorganic composition.

For example, (i) a method of feeding a predetermined amount of water to a reactor, adding a predetermined amount of the solute, further adding a predetermined amount of a previously-prepared inorganic dissolution promoter, and stirring the mixture at a predetermined temperature, (ii) a method of feeding a predetermined amount of water to a reactor, adding a predetermined amount of a solute, further adding a predetermined amount of component (A) and the component (B), and stirring the mixture at a predetermined temperature, and the like can be given.

The reaction is carried out in water in the preparation method of the present invention.

There are no specific limitations to water used in the reaction. Any of industrial water, tap water, distilled water, and the like can be used.

The amount of water used for preparing the water-soluble inorganic composition is usually 50 to 2,000 parts by weight, and preferably 100 to 500 parts by weight, for one part by weight of the inorganic dissolution promoter (or the total amount of component (A) and component (B)). Use of water in this range ensures efficient production of a homogeneous aqueous solution of high concentration amorphous water-soluble inorganic composition (water-soluble inorganic composition).

The whole amount of the inorganic dissolution promoter is dissolved in water without leaving a residue by using 100 to 500 parts by weight of water per one part by weight of the inorganic dissolution promoter.

In order to efficiently produce a homogeneous aqueous solution of high concentration amorphous water-soluble inorganic composition (water-soluble inorganic composition), the temperature at which the mixture is stirred in preparing the water-soluble inorganic composition is preferably in a range of 40 to 100° C.

When a metal silicon is used as the solute, the pH value of the resulting water-soluble inorganic composition (aqueous solution) at 20° C. is usually from 10.0 to 14.5, and preferably from 10.6 to 13.5.

After the step of reacting the inorganic dissolution promoter and the solute using metal silicon, boric acid, or borax as the solute, it is preferable to add a step of adding and mixing 5 to 50 parts by weight of an acid-containing alcohol to 100 parts by weight of the reaction solution, wherein the acid-containing alcohol is obtained by adding 1 to 10 parts by weight of at least one acid selected from sulfuric acid, nitric acid, hydrochloric acid, and phosphoric acid to 100 parts by weight of an alcohol having 1 to 4 carbon atoms.

It is possible to control the pH of the resulting water-soluble inorganic composition (aqueous solution) to 4 to 9 by adjusting the amount of the acid-containing alcohol added. The pH of the water-soluble inorganic composition (aqueous solution) at 20° C. is preferably 4 to 9.

As examples of the alcohol having 1 to 4 carbon atoms used, methyl alcohol, ethyl alcohol, n-propyl alcohol, isopropyl alcohol, butyl alcohol, ethylene glycol, propylene glycol, glycerol, and the like can be given. These alcohols may be used either individually or in combination of two or more.

According to the present invention, it is possible to efficiently produce the water-soluble inorganic composition by dissolving the water-insoluble metal silicon or scarcely water-soluble inorganic boron compound in water at a high concentration.

The water-soluble inorganic composition of the present invention is considered to be an aqueous solution of the water-soluble compound dissolved in water at a high concentration, wherein the water-soluble compound is obtained by the reaction of the water-insoluble metal silicon or scarcely water-soluble inorganic boron compound with the inorganic dissolution promoter.

A homogeneous water-soluble inorganic composition in which metal silicon or an inorganic boron compound are dissolved in water at a high concentration can be obtained in excellent reproducibility according to the present invention.

In addition, the water-soluble inorganic composition of the present invention does not cause the problem of environmental pollution even if incinerated or dumped.

2) Method for preparing plasticized substance

The plasticized substance of the present invention is obtained by vaporizing and dehydrating the water-soluble inorganic composition described above to a prescribed water content by heating the composition at 100 to 900° C.

Conventionally known methods can be used for heating the water-soluble inorganic composition at 100 to 900° C. without any specific limitations. For example, a method of heating in an electric furnace, a method of using a microwave oven, a method of heating using a burner, and the like can be given.

The plasticized substance having any optional water content can be efficiently produced by adjusting the heating temperature and heating time using these methods.

Although the water content of the plasticized substance may be arbitrarily determined without a specific limitation, a water content of not more than 30 wt % is preferable.

The water content can be adjusted to any optional value in the range of 30 wt % or less by further heating the resulting plasticized substance.

The water content (wt %) of the plasticized substance of the present invention is determined by placing a known amount of the plasticized substance in a metal container (e.g. an aluminum container), heating at 120° C. for 3 hours, and weighing the residual plasticized substance, and calculating using a formula [(X−Y)/X] ×100, wherein X is the amount (g) of the plasticized substance, and Y is the amount (g) after heating.

According to the present invention, a plasticized substance useful as a material for civil engineering works and building construction (for example, durable heat insulating material etc.) can be efficiently obtained by vaporizing and dehydrating the above-mentioned water-soluble inorganic composition by heating at 100 to 900C.

The plasticized substance of the present invention has excellent processability. It can be made into pellets, for example, for storing and transportation and can be molded at a speed as high as the speed required for processing synthetic resins. In addition, the plasticized substance can be molded by injection in the same manner as the injection processing of synthetic resins.

3) Foamed inorganic substance

The foamed inorganic substance of the present invention can be obtained by adding at least one compound selected from the group consisting of (a) a soluble silicic acid compound, (b) an amorphous silicic acid compound, and (c) water, a polyol, and an isocyanate curing agent to the above-described water-soluble inorganic composition of the present invention, and mixing these materials at a prescribed temperature.

There are no specific limitations to the amount of the additives selected from the group consisting of (a) a soluble silicic acid compound, (b) an amorphous silicic acid compound, and (c) water, a polyol, and an isocyanate curing agent. The amount of such an additive (the total amount when two or more additives are used) is usually 1 to 30 wt % of the water-soluble inorganic composition.

Although the temperature at which the additives selected from the group consisting of (a) a soluble silicic acid compound, (b) an amorphous silicic acid compound, and (c) water, a polyol, and an isocyanate curing agent are added to and mixed with the water-soluble inorganic composition is not particularly limited, the temperature at which the soluble silicic acid compound and amorphous silicic acid compound are added to and mixed with the water-soluble inorganic composition is preferably 100 to 900° C.

In this case, it is considered that the water contained in the water-soluble inorganic composition evaporates to produce steam bubbles, which are dispersed to form a foamed material.

When (c) water, a polyol, and an isocyanate curing agent (such as tolylene diisocyanate (TDI), diglyceride diisocyanate (DDI), etc.) are added to and mixed with the water-soluble inorganic composition, the temperature is 10 to 100° C.

In this case, it is considered that water, a polyol, and an isocyanate curing agent reacts to produce carbon dioxide and bubbles of the carbon dioxide are dispersed to form a foamed material.

The resulting foamed inorganic substance contains a fixed amount of water. The water content is preferably not more than 30 wt %. The water content can be arbitrarily controlled in the range not more than 30 wt % by further heating the resultant foamed inorganic substance.

The water content (wt %) of the foamed inorganic substance of the present invention is determined by placing a known amount of the foamed inorganic substance in a metal container (e.g. an aluminum container), heating at 120° C. for 3 hours, and weighing the residual foamed inorganic substance, and calculating by the formula [(X−Y)/X]×100, wherein X is the amount (g) of the foamed inorganic substance, and Y is the amount (g) after heating.

According to the present invention, a foamed inorganic substance useful as a material for civil engineering works and building construction (for example, durable heat insulating material etc.) can be efficiently obtained.

### EXAMPLES

### Preparation Example 1

Sodium fluoride (NaF) and sodium hydroxide (NaOH) were mixed to obtain mixtures of NaF and NaOH, each in an amount of 10 g, but consisting of NaF and NaOH at a proportion of 1:9, 5:5, and 8:2. Each mixture was dissolved in 100 ml of water to obtain 10 wt % aqueous solutions of inorganic dissolution promoter. The solutions containing NaF and NaOH at a ratio of 1:9, 5:5, and 8:2 are respectively indicated as inorganic dissolution promoter A, inorganic dissolution promoter B, and inorganic dissolution promoter C.

### Example 1

Three aliquots (30 g each) of the inorganic dissolution promoter A (pH=13.0) obtained in Preparation Example 1 were heated at 40° C. and boric acid in an amount of 3 g, 6 g, or 9 g was added to each aliquot. The mixtures were stirred for one hour to obtain transparent solutions (water-soluble inorganic compositions).

Example 2

3 g of boric acid was added to 30 g of the inorganic dissolution promoter C (pH =12.5) obtained in Preparation Example 1 and the mixture was heated to 60° C. while stirring. The mixture turned transparent and its pH was 8.5. 3 g of boric acid was further added to obtain a transparent solution (a water-soluble inorganic composition) with a pH of 5.4.

### Example 3

Three aliquots (30 g each) of the inorganic dissolution promoter B (pH =13.5) obtained in Preparation Example 1 were heated at 70° C. and borax anhydride (99% purity) in an amount of 3 g, 6 g, or 9 g was added to each aliquot. The mixtures were stirred to obtain transparent solutions (water-soluble inorganic compositions). The pH of the resulting aqueous solutions was 13.5.

### Example 4

The inorganic dissolution promoter B obtained in Preparation Example 1 was heated to 40° C. and 3 g of boric acid was added, followed by stirring, to obtain a transparent solution. Then, the amount of boric acid was sequentially increased by adding 3 g of boric acid each time to a total amount of 6 g, 9 g, and ultimately 12 g. The mixture was stirred at the time of each addition to obtain a transparent solution (water-soluble inorganic composition) after each addition. The pH of the transparent solution (water-soluble inorganic composition) finally obtained after the addition of 12 g of boric acid was 6.2.

### Example 5

1,000 ml of water and 300 g of 5 to 25 mm lumps of metal silicon were put into a stainless steel container and warmed at 40° C. 75 g of sodium fluoride and 100 g of sodium hydroxide were added to the mixture as inorganic dissolution promoters. The resulting mixture was stirred for two hours to obtain a homogeneous transparent solution (water-soluble inorganic composition). The heat of reaction was 90° C. or more. The transparent solution had a specific gravity of 1.45 and a pH of 13.0.

### Example 6

Acid-containing alcohols were prepared by mixing 30 g of industrial ethanol with 2 wt % of 96% sulfuric acid, 38% nitric acid, or 35% hydrochloric acid. 100 g of transparent solutions obtained in Example 5 were added to each of the acid-containing alcohols and the mixtures were stirred. Floating water produced when the alcohols were mixed was removed to obtain about 70 to 80 g of viscous materials from each of the mixtures. The resulting viscous materials had a pH of 10.6 to 11.0.

### Examples 7 to 11

Metal silicon purity: 97%) and borax decahydrate (BORAX decahydrate, purity: 98%) in amounts shown in Table 1 were added to 1,500 ml of water. Inorganic dissolution promoters (sodium fluoride and sodium hydroxide) were added to the mixture at different ratios of sodium fluoride and sodium hydroxide shown in Table 1. The resulting mixture was stirred while controlling the temperature at 40° C. or higher.

The proportions and amounts of metal silicon, borax decahydrate, and inorganic dissolution promoters and the pH, specific gravity, and solid-component yield of the resulting water-soluble inorganic compositions are shown in Table 1.

TABLE 1

| | | | | | | | Example | | Example | |
|---|---|---|---|---|---|---|---|---|---|---|
| | Example 7 | | Example 8 | | Example 9 | | 10 | | 11 | |
| Metal silicon | 400 | g | 400 | g | 400 | g | 400 | g | 400 | g |
| Borax | 50 | g | 50 | g | 70 | g | 100 | g | — | |
| decahydrate | | | | | | | | | | |
| Inorganic | 75 | g | 120 | g | 140 | g | 170 | g | 280 | g |
| dissolution | | | | | | | | | | |
| promoter | | | | | | | | | | |
| Sodium | 25 | g | 70 | g | 70 | g | 70 | g | 180 | g |
| fluoride | | | | | | | | | | |
| Sodium | 50 | g | 50 | g | 70 | g | 70 | g | 100 | g |
| hydroxide | | | | | | | | | | |
| Water | 1,500 | g | 1,500 | g | 1,500 | g | 1,500 | g | 1,500 | g |
| pH value | 11.5 | | 11.2 | | 11.1 | | 11.5 | | 10.8 | |
| (20° C.) | | | | | | | | | | |
| Specific | 1.27 | | 1.46 | | 1.64 | | 1.84 | | 1.48 | |
| gravity | | | | | | | | | | |
| Solid- | 270 | g | 464 | g | 640 | g | 940 | g | 480 | g |
| component | | | | | | | | | | |
| yield | | | | | | | | | | |

(Note 1) The solid component yield increases as the amount of inorganic dissolution promoters increase (Examples 7 to 10).
(Note 2) The solid component yield increases as the amount of sodium fluoride increases (Examples 8 to 10).
(Note 3) The solid component yield increases as the amount of sodium hydroxide increases (Examples 9 and 10).
(Note 4) The solid component yield increases as the amount of inorganic dissolution promoters increase (Example 10).
(Note 5) A transparent solution can be obtained if the amount of inorganic dissolution promoters is 50% of less of the solutes.

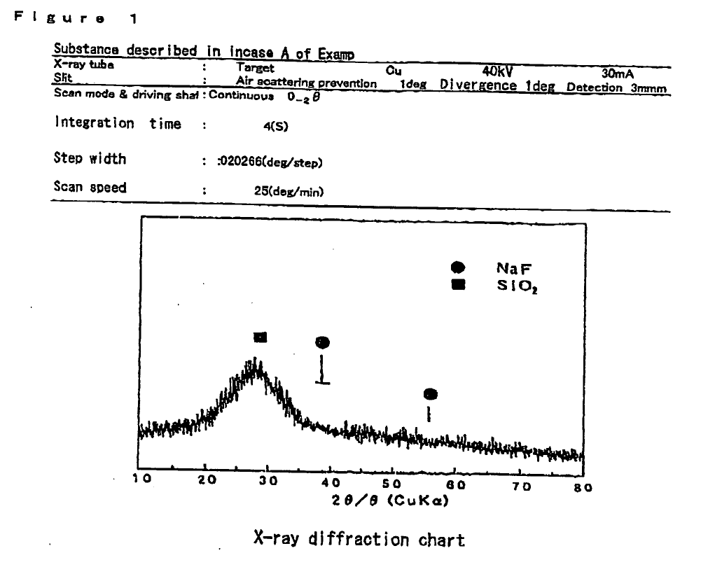

FIG. 1 shows an X-ray diffraction pattern of the water-soluble inorganic composition obtained in Example 7, wherein 2θ/θ (CuK α) is plotted along the horizontal axis and peak intensity is plotted along the vertical axis. FIG. 1 has no peaks indicating crystallinity, showing that the composition is amorphous. The measurements were conducted by Shimazu Techno-Research, Inc.

Experiments conducted in the same manner as in Examples 7 to 11 by replacing sodium fluoride with sodium phosphite or sodium sulfite confirmed production of homogeneous water-soluble uniform inorganic compositions. Detailed descriptions are omitted. Production of homogeneous water-soluble inorganic compositions was also confirmed by using lithium hydroxide and potassium hydroxide instead of sodium hydroxide.

### Example 12

Water-soluble inorganic compositions were prepared in the same manner as in Example 7 except for using sodium sulfite, sodium nitrite, or sodium phosphite instead of sodium fluoride. The products are herein indicated as water-soluble inorganic composition (A-MS), watersoluble inorganic composition (A-MO), and water-soluble inorganic composition (A-MP), respectively.

Acid-containing ethanols were prepared by mixing 100 g of industrial grade ethanol with 96% sulfuric acid, 38% nitric acid, 86% phosphoric acid, or 35% hydrochloric acid, each in an amount of 1 to 1.5 wt %. To 30 g of each of these acid-containing alcohols was added 100 g each of the water-soluble inorganic compositions (A-MS), (A-MO), and (A-MP) and the mixtures were gently stirred to remove floating water produced by dehydration of alcohol. The yield was 70 to 82 g in the order (A-MS)>(A-MO)>(A-MP).

The pH of the resulting water-soluble inorganic compositions was 10.0 to 10.4.

### Example 13

The water-soluble inorganic compositions obtained in Example 12 had reduced plasticity and were brittle. The compositions increased their viscosity and plasticity when alcohol was removed by heating at 40° C. It was possible to obtain sheet-like plasticized substances with an optional thickness from 0.2 mm to 2 mm.

The water content of the resulting plasticized substances was 10 to 30 wt %.

The water content (wt %) of the plasticized substances was determined by placing 5 g of the plasticized substance in an aluminum container, heating at 120° C. for 3 hours in an electric furnace, and weighing the residual plasticized substance (Y(g)), and calculated using a formula [(5−Y)/]×100 (hereinafter the same, the water contents of foamed inorganic substances were determined in the same manner).

### Example 14

100 g of the water-soluble inorganic composition obtained in Example 5 was mixed with 30 g of industrial grade ethanol to which 2 wt % of 35% hydrochloric acid was added, at room temperature. pH of the resulting composition was 9.6. After removing floating water, the composition was heated to remove alcohol to obtain a transparent glutinous starch syrup-like liquid.

The liquid product was heated at 60° C. for 10 minutes to dehydrate by evaporation, thereby obtaining a flexible plasticized substance.

The water content of the resulting plasticized substance was 10 to 30 wt %.

### Example 15

“Radiolite” (diatomaceous earth manufactured by Showa Chemical Industry, Co., Ltd.) was added to and mixed with the water-soluble inorganic composition obtained in Example 5 in an amount of 10 wt % of the composition. A paper cup was charged with 30 g of the resulting mixture and heated in a 500W microwave oven for 3 minutes (heated at 300° C. or more) to obtain a cured product.

The water content of the resulting cured product was 31 wt %.

The cured product was allowed to stand in water for seven days to confirm that strength was maintained and the product was water-resistant.

Besides diatomaceous earth soluble silicic acid, glass, and pozzlana white carbon can also be used.

### Example 16

100 g of the water-soluble inorganic composition obtained in Example 5 was mixed with 10 g of an amorphous silicic acid compound and the mixture was sufficiently stirred. The resulting mixture was heated in an electric furnace at 500° C. for 10 minutes to obtain a foamed inorganic substance. The specific gravity of the foamed inorganic substance was 0.2.

The water content of the foamed inorganic substance was 5 to 30 wt %.

The product was a waterproofing material.

### Example 17

1 to 15 g of isocyanurmelamine was added to 100 g of the water-soluble inorganic composition obtained in Example 8 and mixture was heated to become foamed and cured using a microwave oven, thereby obtaining a foamed inorganic substance.

The water content of the foamed inorganic substance was 5 to 30 wt %.

Foamed inorganic substances, obtained by adding 5 g or more of isocyanurmelamine to 100 g of the water-soluble inorganic composition, and heating the mixture to become foamed and cured, possessed outstanding waterproofing and fireproofing properties.

### Example 18

300 of the water-soluble inorganic composition obtained in Example 6 was sufficiently mixed with 100 g of acid-containing ethanol containing 1.5 g of hydrochloric acid. Floating water was discharged to obtain 240 g of a transparent solution.

1 to 25 g of cyanuric acid was kneaded with the transparent solution to obtain a plasticized substance which is suitable to be processed into a sheet.

A plasticized substance obtained by adding cyanuric acid to the transparent aqueous solution in an amount of 5 wt % was heated at 250° C. to obtain a foamed inorganic substance with excellent waterproofing properties.

The water content of the foamed inorganic substance was 5 to 30 wt %.

### Example 19

A product having a hard surface and containing water inside was obtained by pulverizing or palletizing the plasticized substance obtained in Example 18 and drying the particles or pellets in air. The resulting product was put into a silicon rubber mold and heat-pressed at 300° C. to obtain a plate having a specific gravity of 0.2. Even pellets allowed to stand for one month could be made into a foamed inorganic substance, if put into a paper cup and heated in a microwave oven for 2 to 5 minutes.

The water content of the foamed inorganic substance was 5 to 30 wt %.

### Examples 20 to 25

100 to 600 g of the water-soluble inorganic composition obtained in Example 1 was added to 100 g of a polyol. After addition of a prescribed amount of water and DDI, the mixture was sufficiently stirred at room temperature (20 to 25° C.) to obtain a foamed organic-inorganic composite material.

The amounts of the polyol, water-soluble inorganic composition (PHN, water content: 40 wt %), water, and DDI and the foamed volume (cm³) are shown in Table 2.

The foamed volume was determined by putting the resulting foamed inorganic substance into a specific amount of oil and measuring the volume increase (cm³) over a prescribed amount.

TABLE 2

| | | | Exam- | Exam- | Exam- | Exam- |
|---|---|---|---|---|---|---|
| | Example | Example | ple | ple | ple | ple |
| | 20 | 21 | 22 | 23 | 24 | 25 |
| Polyol (g) | 100 | 100 | 100 | 100 | 100 | 100 |
| PHN (g) | 150 | 200 | 300 | 400 | 500 | 600 |
| Water (g) | 30 | 100 | 150 | 200 | 250 | 400 |
| DDI (g) | 100 | 55 | 100 | 100 | 100 | 120 |
| Foamed | 350 | 300 | 380 | 400 | 430 | 450 |
| volume | | | | | | |
| (cm²) | | | | | | |

It can be seen from Table 2 that foamed organic and inorganic materials can be efficiently obtained by adding a polyol and an isocyanate curing agent (DDI) to the water-soluble inorganic composition of the present invention and mixing them at ordinary temperature to become foamed. A nonflammable foamed object can be obtained by adding a nonflammable agent (antimony, etc.) to the foamed organic and inorganic material. Such a nonflammable foamed object can be used as a nonflammable heat insulating material of a fire-resistant panel.

1. A water-soluble inorganic composition obtained by reacting an inorganic dissolution promoter with at least one solute selected from the group consisting of metal silicon, boric acid, and borax at a ratio of the inorganic dissolution promoter to the solute of 1:10 to 1:100 by weight, wherein the inorganic dissolution promoter is obtained by mixing in water (A) at least one compound selected from the group consisting of an alkali metal fluoride, an alkali metal phosphite, an alkali metal sulfite, an alkali metal nitrite, sulfurous acid, nitrous acid, and phosphorous acid, alkali metal phosphate, alkali metal nitrate, alkali metal sulfate, phosphoric acid, nitric acid, sulfuric acid and (B) at least one alkali metal hydroxide at a ratio of (A):(B) of 1:9 to 4:1 by weight.

2. The water-soluble inorganic composition according to claim 1, obtained by using 100 to 500 parts by weight of water per one part by weight of the inorganic dissolution promoter.

3. The water-soluble inorganic composition according to claim 1, wherein the solute is metal silicon and the aqueous solution has a pH of 10.6 to 13.5 at 20° C.

4. The water-soluble inorganic composition according to claim 3, which is an aqueous solution obtained by further adding boric acid, borax, or a boron compound containing the boric acid or borax to the reaction system when reacting the inorganic dissolution promoter with the solute.

5. The water-soluble inorganic composition according to claim 1, wherein the solute is boric acid or borax and the aqueous solution has a pH of 4 to 9 at 20° C.

6. The water-soluble inorganic composition according to claim 1, obtained by adding and mixing S to 50 parts by weight of an acid-containing alcohol to 100 parts by weight of the reaction solution of the inorganic dissolution promoter and the solute, wherein the acid-containing alcohol is obtained by adding 1 to 10 parts by weight of at least one acid selected from the group consisting of sulfuric acid, nitric acid, hydrochloric acid, and phosphoric acid to 100 parts by weight of an alcohol having 1 to 4 carbon atoms.

7. A plasticized substance obtained by vaporizing and dehydrating the water-soluble inorganic composition according to claim 1 to a prescribed water content by heating it at 100 to 900° C.

8. The plasticized substance according to claim 7, having a water content of 30 wt % or less.

9. A foamed inorganic substance obtained by adding at least one compound selected from the group consisting of (a) a soluble silicic acid compound, (b) an amorphous silicic acid compound, and (c) water, a polyol, and an isocyanate curing agent, to the water-soluble inorganic composition according to claim 1, and mixing these materials at a prescribed temperature.

10. The water-soluble inorganic composition according to claim 2, wherein the solute is metal silicon and the aqueous solution has a pH of 10.6 to 13.5 at 20° C.

11. The water-soluble inorganic composition according to claim 2, wherein the solute is boric acid or borax and the aqueous solution has a pH of 4 to 9 at 20° C.

12. The water-soluble inorganic composition according to claim 2, obtained by adding and mixing S to 50 parts by weight of an acid-containing alcohol to 100 parts by weight of the reaction solution of the inorganic dissolution promoter and the solute, wherein the acid-containing alcohol is obtained by adding 1 to 10 parts by weight of at least one acid selected from the group consisting of sulfuric acid, nitric acid, hydrochloric acid, and phosphoric acid to 100 parts by weight of an alcohol having 1 to 4 carbon atoms.

13. The water-soluble inorganic composition according to claim 3, obtained by adding and mixing S to 50 parts by weight of an acid-containing alcohol to 100 parts by weight of the reaction solution of the inorganic dissolution promoter and the solute, wherein the acid-containing alcohol is obtained by adding 1 to 10 parts by weight of at least one acid selected from the group consisting of sulfuric acid, nitric acid, hydrochloric acid, and phosphoric acid to 100 parts by weight of an alcohol having 1 to 4 carbon atoms.

14. The water-soluble inorganic composition according to claim 4, obtained by adding and mixing S to 50 parts by weight of an acid-containing alcohol to 100 parts by weight of the reaction solution of the inorganic dissolution promoter and the solute, wherein the acid-containing alcohol is obtained by adding 1 to 10 parts by weight of at least one acid selected from the group consisting of sulfuric acid, nitric acid, hydrochloric acid, and phosphoric acid to 100 parts by weight of an alcohol having 1 to 4 carbon atoms.

15. The water-soluble inorganic composition according to claim 5, obtained by adding and mixing S to 50 parts by weight of an acid-containing alcohol to 100 parts by weight of the reaction solution of the inorganic dissolution promoter and the solute, wherein the acid-containing alcohol is obtained by adding 1 to 10 parts by weight of at least one acid selected from the group consisting of sulfuric acid, nitric acid, hydrochloric acid, and phosphoric acid to 100 parts by weight of an alcohol having 1 to 4 carbon atoms.

16. A plasticized substance obtained by vaporizing and dehydrating the water-soluble inorganic composition according to claim 2 to a prescribed water content by heating it at 100 to 900 C.

17. A plasticized substance obtained by vaporizing and dehydrating the water-soluble inorganic composition according to claim 3 to a prescribed water content by heating it at 100 to 900° C.

18. A plasticized substance obtained by vaporizing and dehydrating the water-soluble inorganic composition according to claim 4 to a prescribed water content by heating it at 100 to 900° C.

19. A plasticized substance obtained by vaporizing and dehydrating the water-soluble inorganic composition according to claim 5 to a prescribed water content by heating it at 100 to 900° C.

20. A plasticized substance obtained by vaporizing and dehydrating the water-soluble inorganic composition according to claim 6 to a prescribed water content by heating it at 100 to 900° C.
